(19) United States
(12) Patent Application Publication
(10) Pub. No.: US 2022/0048083 A1
(43) Pub. Date: Feb. 17, 2022

(54) SELF-CLEANING SINK

(71) Applicant: Matthew Quinn, Sugar Hill, GA (US)

(72) Inventor: Matthew Quinn, Sugar Hill, GA (US)

(21) Appl. No.: 17/400,231

(22) Filed: Aug. 12, 2021

Related U.S. Application Data
(60) Provisional application No. 63/064,485, filed on Aug. 12, 2020.

(51) Int. Cl. B08B 9/08; E03C 1/182

(52) U.S. Cl. CPC B08B 9/08; B08B 2209/08; E03C 1/182

(57) ABSTRACT

A self-cleaning sink has an undermounted bowl connected to a countertop. The perimeter of an internal bowl portion extends about a perimeter of a sink access permitting access through the countertop into the bowl and a base of the countertop spaces the internal bowl portion from the sink access perimeter. The base has at least one port in communication with a cross passage which selectively directs water into the bowl in a self-cleaning.

### CLAIM OF PRIORITY

This application claims the benefit of U.S. Provisional Application No. 63/064,485 filed Aug. 12, 2020 which is incorporated by reference in its entirety herein.

### FIELD OF THE INVENTION

The present invention relates to a sink construction having a self-cleaning or self-rinsing feature, and more particularly to an undermounted sink having undermounted water ports which selectively direct water in a swirling manner about an interior bowl surface to wash the interior surface of the bowl before exiting through a drain.

### BACKGROUND OF THE INVENTION

There have been several efforts at patenting self-cleaning sinks such as U.S. Published Application 2016/0069054, U.S. Pat. Nos. 6,289,530, 7,155,759, 2,847,681, and likely others.

Nevertheless, the Applicant believes there is still a need for an improved self-rinsing or self-cleaning sinks to be available on the marketplace.

### SUMMARY OF THE INVENTION

It is an object of many embodiments of the present invention to provide a self-rinsing or self-cleaning sink.

It is also the object of many embodiments of the present invention to provide a self-rinsing or self-cleaning sink undermounted below a counter. A plurality of outlets or ports may direct water along an interior bowl surface in a radial, circumferential or swirling manner in an effort to provide a rinsing effect about the bowl before being directed by gravity out of the drain disposed toward a bottom of the bowl.

It is an object of many embodiments in the present invention to provide a self-rinsing sink having a channel machined or otherwise formed into a bottom portion of the countertop which receives an upper lip of the bowl therein. A cross passage, possibly extending a deeper depth or elevation than the channel, may be machined or otherwise formed into the countertop. The cross passage communicates with a plurality of outlets or ports located under the countertop and disposed internally relative to the bowl to direct water on the interior surface of the bowl. The cross passage may communicate water from external to the bowl over or past the bowl at or through the cross passage and then into a slot in communication with the outlets/ports when activated. A water supply is selectively in communication with the cross channel external to the bowl so that when the water is provided through the water supply, the water passes through the cross passage and proceeds into the slot (which may circumnavigate the bowl internally to the bowl) and direct water to the plurality of outlets to then dispense water into the bowl in a swirling manner.

Accordingly, in accordance with a presently preferred embodiment of the present invention, a sink may have a bowl provided below a countertop such as a solid surface, granite, or other countertop whereby a sink access cutout is provided completely therethrough. Radially external to the sink access on a bottom surface of the countertop is a first channel which circumnavigates the sink access and receives an upper lip of a bowl therein. A cross passage passes above, around and/or through, the upper lip of the bowl (below an upper surface of the countertop) so as to communicate the cross-channel to at least one, if not a plurality of outlets or ports, preferably connected by a slot which may circumnavigate the sink access radially external to the sink access while being located internal or adjacent to an internal bowl surface (where it contacts the countertop). The slot may assign it in defining a duct with the inner bowl surface to direct water from the cross passage to the outlets/ports.

Water may selectively be directed from a supply to the cross passage for delivery through the port(s). The outlets or ports may be machined or otherwise formed into an underside of the countertop internal to the bowl to then direct the fluid preferably at any angle internal to the bowl for a swirling motion (i.e. the water proceeds in rotational direction) for a self-rinsing or self-cleaning aspect of the sink before being directed out a drain in the bowl. A controller, such as directed by a switch, may selectively activate a valve to permit the rinsing action, possibly for as long as the controller is activated, a predetermined time, a predetermined value and/or other factor.

### BRIEF DESCRIPTION OF THE DRAWINGS

The particular features and advantages of the present invitation will become apparent from the following description when considered in conjunction with the accompanying drawings in which:

FIG. 1 is a top perspective view of a preferred embodiment of the present invention;

FIG. 2 is a bottom perspective view of the embodiment shown in FIG. 1 with the sink bowl removed;

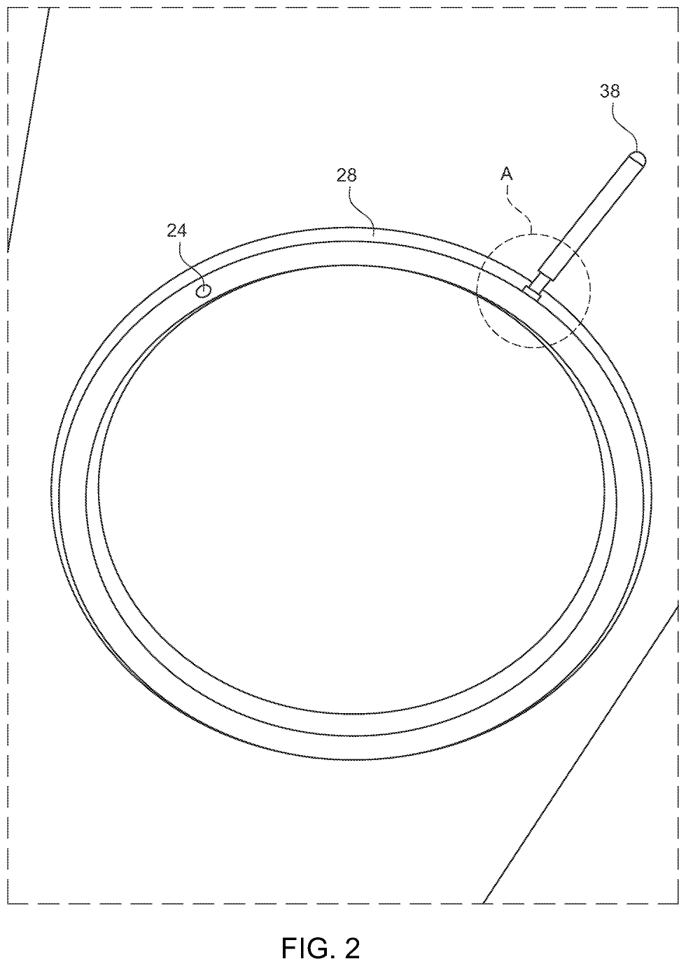

FIG. 3 is a bottom perspective view of detail A shown in FIG. 2;

FIG. 4 is a bottom perspective view similar to FIG. 3 with the bowl installed as shown in FIG. 1; and

FIG. 5 is a bottom perspective view similar to FIGS. 3 and 4 with the drain and a water supply connection installed.

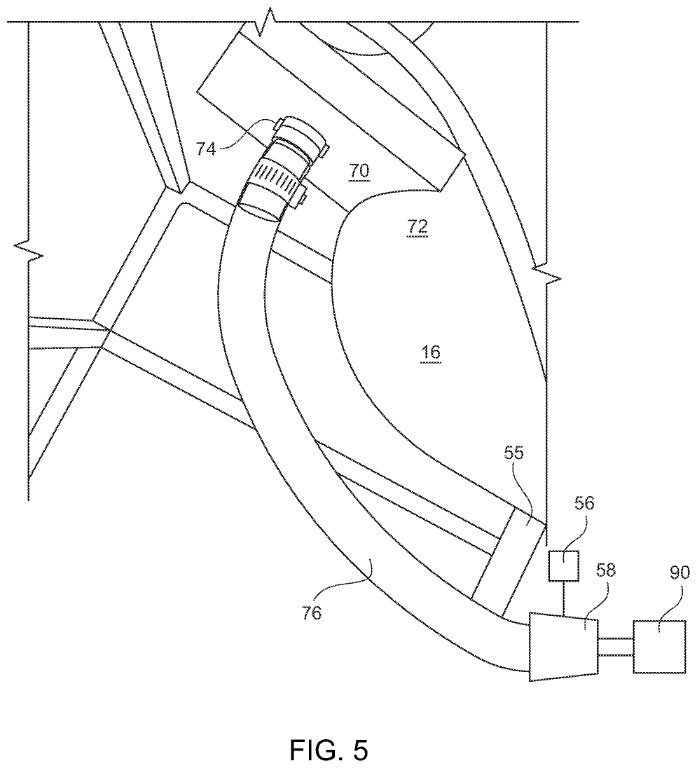

### DETAILED DESCRIPTION OF THE INVENTION

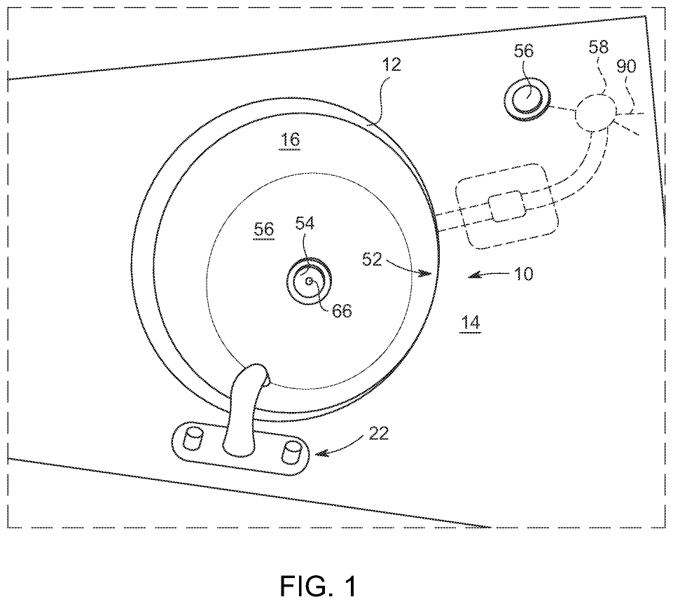

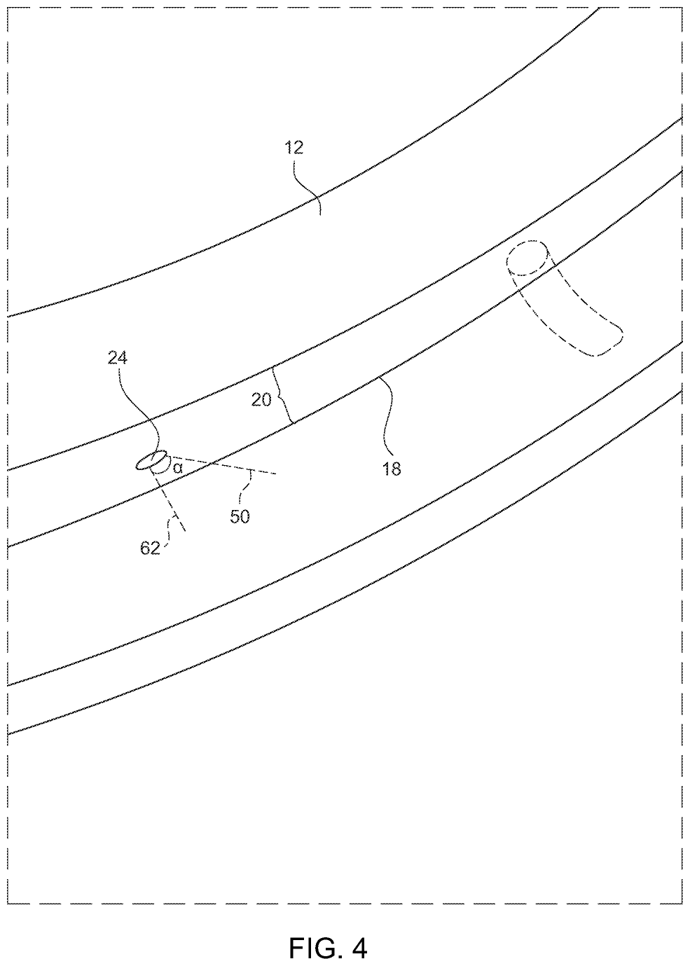

FIG. 1 shows a sink 10 having a sink access 12 defined by a perimeter which may be cut into or otherwise provided internal to a countertop 14. Many techniques exist to form or provide a sink access 12 internal to a countertop 14. Countertop 14 could be a solid surface, granite, or other appropriate countertop material. The perimeter of sink access 12 is preferably shorter than and contained within a perimeter of an internal perimeter of a bowl 16 such as a toward or at upper end 18 as shown in FIG. 4 when connected. Sink access 12 could have any desired perimeter shape which may or may not be the same shape as bowl 16 at upper end 18.

The sink 10 preferably has a self-cleaning or a self-rinsing feature in that a water supply 90 (preferably separately connected from faucet 22) provides water through one or more, such as a plurality of, ports 24. This construction will be described in further detail below.

Ports 24 may be drilled openings which connect with a slot 26 which preferably extends radially internally relative to channel 28 which is preferably cut or otherwise disposed circumferentially (or radially externally) about the sink access 12 but extends into a lower surface 30 of the countertop 14, such as within lip 35. The channel 28 is preferably in communication with each of the ports 24 until a bowl 16 is connected thereto.

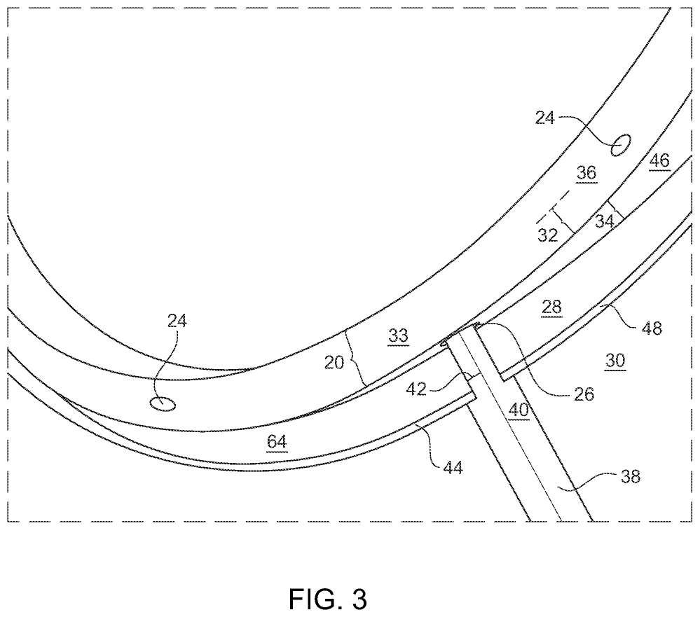

The slot 26 may extend a length 32 into a base 36 spaced by a height 34 from a bottom surface 37 of the base 36. The bottom surface 37 of the base may be coplanar with a lower surface 30 of the countertop 14 external to the channel 28. One or more ports 24 may be drilled or otherwise provided through the height 34 of the base 36 so as to communicate the port(s) 24 with the slot 26 as can be seen from FIG. 3 and others.

Meanwhile, cross passage 38 may be provided into the countertop 14. The cross passage 38 may have a groove 40 which extends a depth 42 deeper than depth 44 of channel 28 for some embodiments. This feature, if provided, may allow water to communicate from the cross-channel 38 (external to channel 28) through groove 40 and into the slot 26 when the bowl 16 is installed (as shown in FIG. 3). Other cross passages 38 may proceed below an upper lip of the bowl 16 (such as through a bore in the bowl 16 or otherwise). The bowl 16 may preferably provide a watertight connection against outer edge 46 of base 20. Similarly, an exterior surface of the bowl 16 may contact exterior edge 48 of groove 28. Thus, a watertight connection can be provided so that any water directed from the cross-channel 38 may proceed through port(s) 24 and then based on the angular nature of the ports 24, as represented by flow path 50, a swirling effect represented by arrows 52 may be achieved in the bowl 16. Water may drain out drain 54 and drain pipe 55 to provide a self-cleaning, or swirling motion internal to the bowl 16 along an interior surface 56 thereof such as radially about axis 66.

Switch 56 may connect to a processor 58 and to selectively communicate water to the port(s) 24 and into the bowl 16. For some embodiments, the switch 56 may provide a signal to the processor 58 so as to communicate a certain amount of water, or a certain time period of water flow for the cleaning operation. Other embodiments may have the processor open an internal valve as long as the switch is depressed (or until pressed again) to shut the valve to stop additional water flow.

In at least some preferred embodiments, the ports 24 are preferably located in the base 36 and are located along the base 36 which is disposed radially internally to the sink access 12 from the interior surface 56 of the sink bowl 16 at an upper end 18. The port(s) 24 preferably are angularly oriented relative to a vertical axis 62 such as at an angle alpha (α) so as to assist in starting the swirling motion in the bowl 16 upon activation. For some embodiments, the ports 24 may be angled in the direction 50 so as water contacts the bowl 16 at a relatively high elevation, i.e., towards the countertop 14 (and towards the upper end 18 of the bowl 16). The bowl 16 of the sink 10 is preferably an undermounted bowl which can be connected by securing its lip (or top edge) in the groove 28 not only at the top 64 of the groove, but also possibly at the sides 46, 48. The bowl 16 preferably has an interior surface 56 which, for at least some embodiments, may be somewhat similar to an exterior surface (at least towards the upper end 18 or at least cooperate with a channel 28 which may contact up against the edge 48 of the channel 28 towards the top 18 of the bowl 16). The base 36 preferably has a bottom surface 37 which is co-planer with the bottom 30 of the countertop 14 for many embodiments.

The channel 28 as well as the groove 40 and slot 26 may be machined into the countertop 14 or otherwise formed therein. The ports 24 could also be machined and/or drilled. When assembling the sink 10, the bowl 16 is preferably connected to the channel 28, the cross passage 38 portion external to the bowl 16 may have a stop 70 covering it over which could be connected to the bottom surface 30 of the countertop 14 external to the bowl 18 as well as against an external surface 72 of the bowl 16. Any water proceeding into the cross passage 38 would then proceed out of the ports 24 when received from a connection 74 connected to stop 70. Hose 76 is shown connecting to a supply 90 and connected at connection 74. For some embodiments the bowl 16 could be manufactured to have a bore or other passage therethrough or there about so that the cross passage 38 could communicate water through or about the bowl 16 so as to then communicate with the slot 26. The slot 26 for many embodiments can be created as an effective ledge or lip 33 formed with the channel 28 extending into the slot at the depth 34 of the edge 46 internal to the slot 26 the length 32 so as to form that lip 33 and a corresponding water channel. Other embodiments may have different constructions.

One purpose of at least some preferred embodiments of a self-cleaning or self-rinsing sink 10 may be to provide a relatively easy way to wash the bowl 16 after uses so as to keep the bowl 16 clean. The controller 58 may be useful to control the amount of time and/or volume of water that runs into the bowl 16 which may also include an internal solenoid valve that shuts the water off as well as an on/off switch 56 that may direct water towards each of the ports 24 which may be spaced roughly four to six inches or other appropriate spacing to wash the bowl 16.

When the switch 56 is activated, the controller 58 may activate the solenoid or other valve for a programmed amount of time to be opened and then shut off (or provide any other dispensing operation as described herein). The water can be disbursed through the ports 24 from along an inside of the bowl 16 at the spacing described above. The slot 26 may provide water channel with the bowl 16. The placement of the ports 24 can direct the water into the bowl 16 in a swirling motion to at least assist in rinsing the inside of the bowl 16 from toward the top 18 downward in a circular or swirling motion thereby encouraging soap or other material to run down toward the center 66 of the sink 10 and/or the bowl 16 to the drain 54 for disposal through drain pipe 55. The water from supply 90 preferably contacts the bowl 16 at a direction along internal surface sufficient to encourage debris, soap, etc. in the bowl 16 from the sink access 12 to be directed out drain 54.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the intention are intended to be included within the scope of the appended claims.

Having thus set forth the nature of the invention, what is claimed herein is:

1. A sink comprising:
a countertop having a sink access cutout extending therethrough;
a bowl having an outer internal bowl perimeter is connected to a bottom surface of the countertop, wherein the internal bowl perimeter circumnavigates the sink access cutout and is spaced by a base of the countertop therefrom;
a cross passage extending from below and into the countertop communicating to at least one port in the base oriented towards an internal bowl surface.

2. The sink of claim 1 wherein the countertop is selected from one of a solid surface material and granite.

3. The sink of claim 1 wherein the at least one cross passage extends at least one of above, around and through the internal bowl surface.

4. The sink of claim 1 wherein the at least one port is comprised of a plurality of ports.

5. The sink of claim 1 further comprising a channel extending into the bottom surface of the countertop, said channel receiving the bowl therein.

6. The sink of claim 5 wherein the cross passage has a groove extending further into the bottom surface of the countertop than the channel.

7. The sink of claim 6 wherein the base has a slot extending radially internally to the channel above a bottom surface of the base and in communication with the at least one port and the cross passage.

8. The sink of claim 7 wherein the bowl provides a watertight connection against the base.

9. The sink of claim 7 wherein the at least one port is a plurality of ports about the base.

10. The sink of claim 9 further comprising a switch directing an input related to the supply of water to the cross passage and into the bowl through the at least one port.

11. The sink of claim 10 further comprising a controller controlling at least one of the amount of time and water is provided into the bowl.

12. A sink comprising:
a countertop having a sink access defining a perimeter internal to the countertop and extending through the countertop from top to bottom;
a bowl connected to a bottom surface of the countertop, said bowl having an internal perimeter, wherein the perimeter of the sink access is shorter than, and contained within the internal perimeter of the bowl;
a base of the countertop spacing the internal perimeter of the bowl from the perimeter of the skin access;
at least one cross passage in the countertop communicating external from the bowl to a port in the base.

13. The sink of claim 12 wherein the at least one cross passage extends at least one of above, around and through the internal bowl surface.

14. The sink of claim 12 wherein the at least one port is comprised of a plurality of ports.

15. The sink of claim 12 further comprising a channel extending into the bottom surface of the countertop, said channel receiving the bowl therein.

16. The sink of claim 15 wherein the cross passage has a groove extending further into the bottom surface of the countertop than the channel.

17. The sink of claim 16 wherein the base has a slot extending radially internally to the channel above a bottom surface of the base and in communication with the at least one port and the cross passage.

18. The sink of claim 17 wherein the bowl provides a watertight connection against the base.

19. The sink of claim 17 wherein the at least one port is a plurality of ports about the base.

20. The sink of claim 19 further comprising a switch directing an input related to the supply of water to the cross passage and into the bowl through the at least one port.
